(19) United States
(12) Patent Application Publication
(10) Pub. No.: US 2025/0363512 A1
(43) Pub. Date: Nov. 27, 2025

(54) SYSTEM AND METHOD FOR COST MANAGEMENT

(71) Applicant: Albertsons Companies, Inc, Boise, ID (US)

(72) Inventors: Weiyu ZHU, Eagle, ID (US); Christopher COWGILL, Littleton, CO (US); Cheston EASTER, Princeton, MO (US); Hit VACHHANI, Allen, TX (US); Prince SONI, Plano, TX (US); Chad BARTELL, Smackover, AR (US)

(21) Appl. No.: 18/669,764

(22) Filed: May 21, 2024

(51) Int. Cl. G06Q 30/0201

(52) U.S. Cl. CPC G06Q 30/0206

(57) ABSTRACT

A system and user interface are provided that determine cost of production for a plurality of products and maintains and updates the cost determinations having cost models associated with the products and product line monitoring of the costs over time.

### BACKGROUND

The present disclosure generally relates to systems, and methods for cost management. More specifically, the present disclosure relates to systems and methods for cost management using cost models having a plurality of cost component types that automatically update based on external cost data sources.

Retailers are at a negotiation disadvantage when they are lacking current and historical information relevant to a product or products in managing and evaluating cost change requests. This problem is further exacerbated when retailers are receiving thousands of cost change requests per week.

### SUMMARY

Systems and methods provide a cost management tool that can model and analyze costs and predict trends in costs going up or down across commodities, product lines, or particular products of interest in real time and provide and easy-to-view and navigate user interface in order to make informed determinations on cost change requests, proactively initiate cost change requests, or on retail pricing.

In some embodiments, a system is provided that determines cost of production for a plurality of products and maintains and updates the cost determinations. The system may have a plurality data sources comprising sources of items of information regarding costs for the plurality of products; a cost model module having one or more cost models associated with each of the plurality products, the cost models incorporating data from the data sources into predefined cost element types to determine cost information for each of the plurality of products over time; and a product line module configured to monitor cost changes over time for a product line formed of a predefined subset of the plurality of products, which displays and updates changes in cost information including cost element type costs, overall costs, and revenue for the products in the product line.

The cost element types may comprise one or more of commodity costs, labor costs, freight costs, or packaging costs. Each of the cost element types comprise a plurality of individual cost elements, and each cost element type is further selectable to display a corresponding cost trend for each of the individual cost elements for one or more of the cost element types.

The plurality of data sources may comprise sources of items of information regarding commodity costs, labor costs, freight costs, and packaging costs.

The system may further include a cost change manager module configured to receive change requests from vendor partners and compare the request with the trend of cost element types, overall costs, and revenue.

The system may further include interactive elements displayed in a user interface configured for selection and deselection to update the displayed cost information over time based on the selection or deselection, or to filter to display a subset of the cost information. The interactive elements may comprise toggles, buttons, hyperlinks, or other user-selectable features in a displayed area.

The product line module may further display cost element type costs, overall costs, and revenue, for each UPC or cost model in the product line.

The product line module may comprise a plurality of product lines, wherein each of the plurality of product lines includes a predefined cost alert threshold that generates a notification when a change in the cost information exceeds a predefined threshold.

The cost model module may be configured to receive information about a new product and automatically associate the new product with an existing cost model based on attributes of the new product.

A user interface may be provided for a system that determines costs of production of a plurality of products having a dashboard displaying a cost model module to associate each of the plurality of products with one or more cost models. The cost models may incorporate data from a plurality data sources into predefined cost element types to provide cost information for each of the plurality of products over time. The dashboard may also have a product line module configured to monitor cost changes over time for a product line formed of a predefined subset of the plurality of products, and display and update changes in cost information including cost element type costs, overall costs, and revenue for the products in the product line.

The cost element types may comprise one or more of commodity costs, labor costs, freight costs, or packaging costs. Each of the cost element types may comprise a plurality of individual cost elements, and each cost element type is further selectable to display a corresponding cost trend for each of the individual cost elements for one or more of the cost element types.

The plurality of data sources may comprise sources of items of information regarding commodity costs, labor costs, freight costs, and packaging costs that automatically feed into the one or more cost models on a pre-defined or real-time basis.

The dashboard may further comprises a cost change manager module configured to receive change requests from vendor partners and compare the request with the trend of cost element types, overall costs, and revenue of a product or product line.

The user interface may further comprise interactive elements configured for selection and deselection to update the displayed cost information over time based on the selection or deselection, or to filter to display a subset of the cost information. The interactive elements may include toggles, buttons, hyperlinks, or other user-selectable features in a displayed area.

The product line module may further display cost element type costs, overall costs, and revenue, for each UPC or cost model in the product line.

The product line module may comprise a plurality of product lines, wherein each of the plurality of product lines includes a predefined cost alert threshold that generates a notification when a change in the cost information exceeds a predefined threshold.

The cost model module may be configured to receive information about a new product and automatically associate the new product with an existing cost model based on attributes of the new product.

### BRIEF DESCRIPTION OF THE DRAWINGS

The drawings disclose exemplary embodiments in which like reference characters designate the same or similar parts throughout the figures of which:

FIG. 1 illustrates a cost analysis system according to the claimed invention;

FIG. 2 displays a dashboard interface of the system having a plurality of modules;

FIG. 3 shows an interface of the data source module;

FIG. 4 shows a cost model module interface;

FIG. 4a shows an interface for linking cost models to a UPC;

FIG. 5 is the product line monitoring module interface;

FIG. 5A shows a product line interface with a list of product lines;

FIG. 5B shows a list of items linked to a selected product line;

FIG. 5C is a view of some the list of model cost elements for a selected model in the product line;

FIG. 5D is a view of a summary of information cost element changes over a defined time period for the selected product line;

FIG. 5E is a detailed view of cost trends for a selected UPC included in the product line;

FIG. 5F is a detailed view of all UPCs in the product line;

FIG. 6 shows a cost change request interface;

FIG. 6A illustrates an interface of cost change request projects; and

FIG. 6B illustrates a detailed view of an item in a cost change request project.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

It is understood that many universal product codes “UPCs” may be linked to a single retailer material item code “SMIC” in the disclosed embodiments. It is further understood that a user may be a retailer or a business. It is further understood that interactive elements include any of toggles, buttons, hyperlinks, or any other manipulatable features in the user interfaces disclosed.

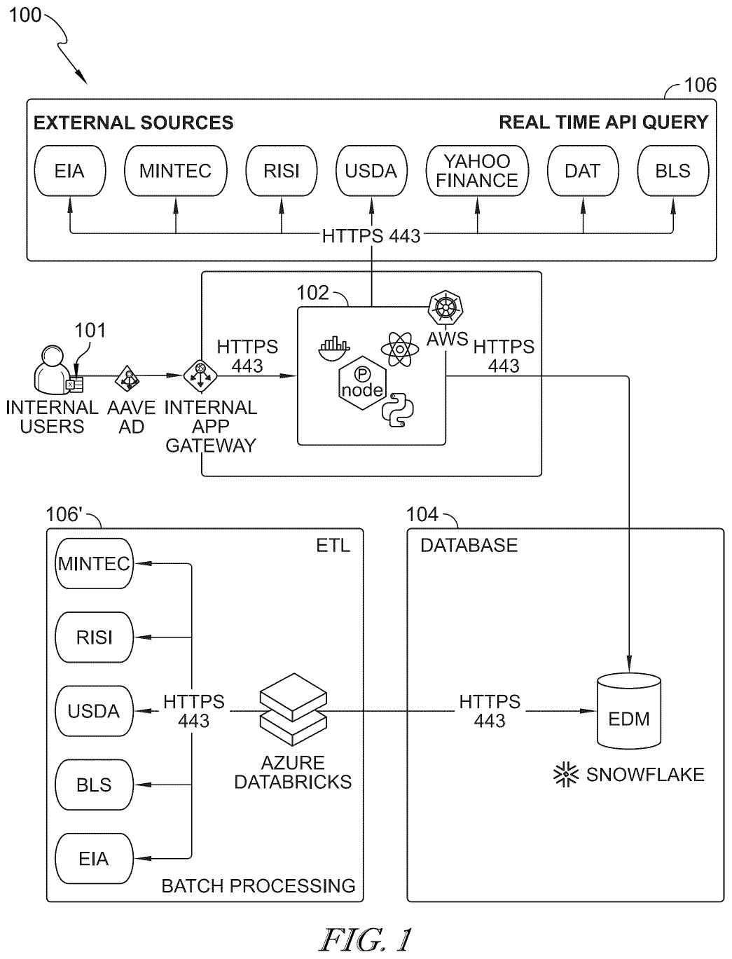

Referring to FIG. 1, a system 100 is shown and described that provides an interface 101 allowing a user to observe and manipulate a multitude of inputs across cost models that analyze and predict product costs in real time. The modeling of product costs is based on extensive aggregation of data from a plurality of databases and data sources. The system may include a user interface 101 and platform 102, an internal database 104 for enterprise data management, and a plurality of integrated external databases or data sources 106 106′. Databases 106 are integrated with platform 102 so that real-time and discrete queries may be run against data in the respective external databases and so that the cost models may be shared and used across pricing, promotion and other systems. Databases 106′ are integrated with database 104 so that databases 106′ are batch processed and internal databased 104 is updated with preselected data sets from external databases 106′ on a predefined cadence. Databases 106, 106′ may be the same databases or different sets of databases.

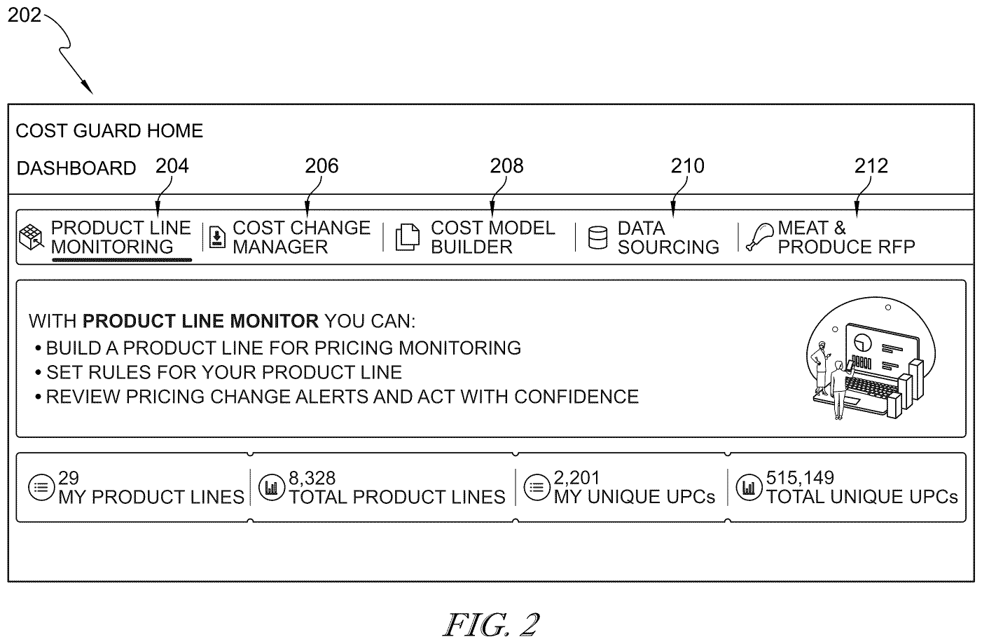

As illustrated in FIG. 2, the system may be accessed via a user interface such as a web browser on an internet enabled device such as a computer or tablet in which a dashboard 202 provides a plurality of navigable modules including product line monitoring module 204. cost change manager module 206, cost model builder module 208, data sourcing module 210, and meat & produce RFP module 212. Meat & Produce RFP module 212 may incorporate USDA meat primal costs from data sourcing module to forecast future primal costs. Future primal cost change alerts may be set for when costs change by a certain percentage for planning of procurement and promotional activities, as well as financial planning.

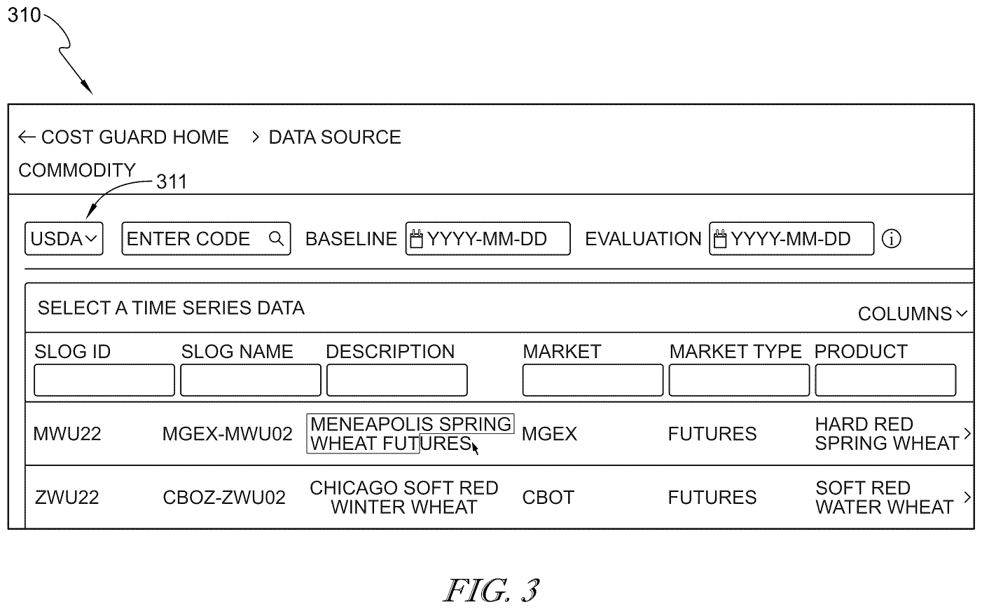

Data sourcing module 310 is configured to pull of information from a plurality of third-party data sources. For example, Data Sourcing module may pull and standardize data from one or more of the Chicago Mercantile Exchange (CME), Resource Information Systems, Inc. (RISI), the United States Department of Agriculture (USDA), Mintec Commodity Price Forest Service, Yahoo Finance, Class and Component Prices-Agricultural Marketing Service, Advanced Price and Pricing Factors, DAT Freight & Analytics, the Department of Labor (DOL), and the Energy Information Administration (EIA). The system may be configured for data sourcing module 310 to pull data weekly, monthly, or on another preset cadence from these data sources. Along with the automated external data pulling, transforming, and standardizing, data sourcing module allows for manual upload of additional data sources such as holidays, pandemic or other external cost driving information, and integration with internal data sources of a business or retailer having information such as revenues, units sold, retail prices, and cost change history. As shown in FIG. 3, a dropdown data source menu 311 provides a list of all data sources and filtering via the data source menu 311, for example, for USDA, shows all the data types pulled and available from the selected data source. As shown in FIG. 3, two of the USDA data types are related to hard red spring wheat and soft red winter wheat products.

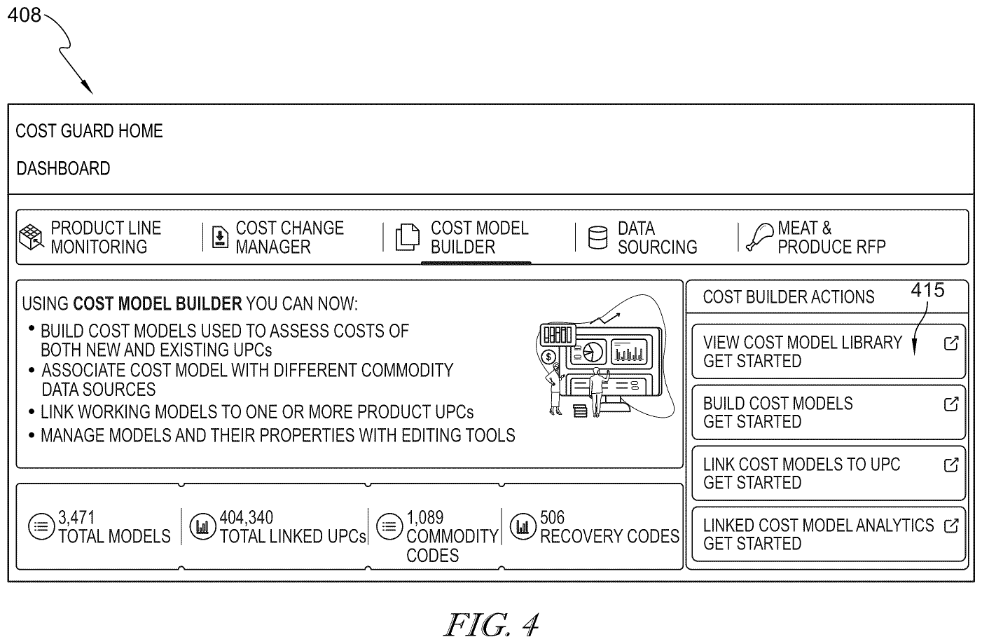

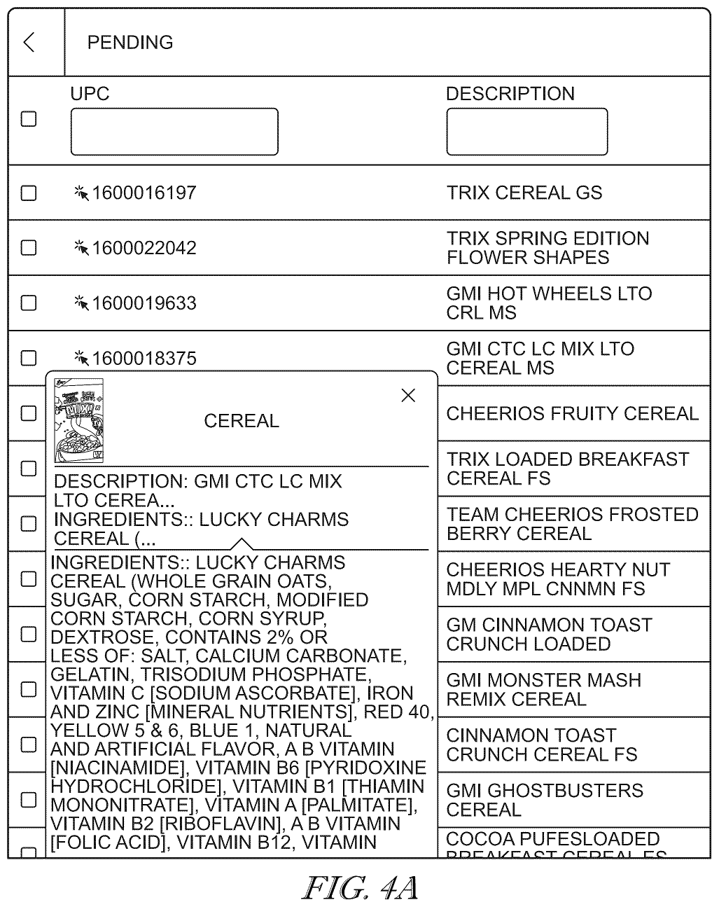

As shown in FIG. 4, cost model builder module 408 may be pre-loaded with any number of product cost models forming a stored cost model library 415. Each cost model may linked with one or more product via the product UPC 413 as described further with respect to FIG. 4A. Within the cost model builder module 408, the library of models may be viewed, cost models may be built, cost models may be linked to products via UPC, and cost model analytics, include cost changes, may be viewed for linked products. Cost models may be associated different commodity data that has been ingested and standardized in format in the data sourcing module 310 depending on the model and corresponding product type. Each cost model breaks down the cost-to-make of a product into multiple cost elements to provide a granular analysis and display of which components, such as ingredients, or freight, are driving the cost or driving changes in cost. Cost model combines and weighs all of these cost element types as well as sub-components, or individual cost elements, to determine fluctuations and trends in costs to make for overall products and trends at the cost element type and cost element level. Cost model builder module 408 allows new models to be built and loaded as needed for types of products. Cost model builder module 408 also may update and display a total number of UPCs linked to cost models by product category, the total number of cost models built and available, the total number of UPCs linked to cost models, and the total number of unique commodity items modeled.

New products or UPCs may be loaded into the system in the cost model module 408 and may be linked to a cost model either by selecting the cost model from the library, or by the system automatically selecting a cost model based on similarity between products. For example, if a newly entered product or products have similar product details or attributes to another product already linked to the cost model, the newly entered products are automatically linked to the same cost model for user approval. Product attributes may include image, description, ingredients, cooking instructions, nutrition factors, etc. as seen in FIG. 4A. The linkage may be formed by on an algorithm using natural language processing to look for similar UPCs based on the attributes. In some instances, the product linkage to a model may be based on a number of attributes in common with already linked products exceeding a predefined threshold,

By way of example, if a plurality of cereal UPCs are uploaded with ingredients, description, and image, cost model builder module 408 may suggest the “boxed cereal” cost model and link the UPC to that model. If the suggested model is incorrect, the user may select a different cost model from the cost model library or create a new cost model. In this manner, many UPCs may be linked to a cost model for a particular product type. Once a product has been modeled or linked to a model, it will remain linked and receive updates from the data sourcing module 310 and may be reviewed in the interface to verify any further cost changes for the life of that product in the business.

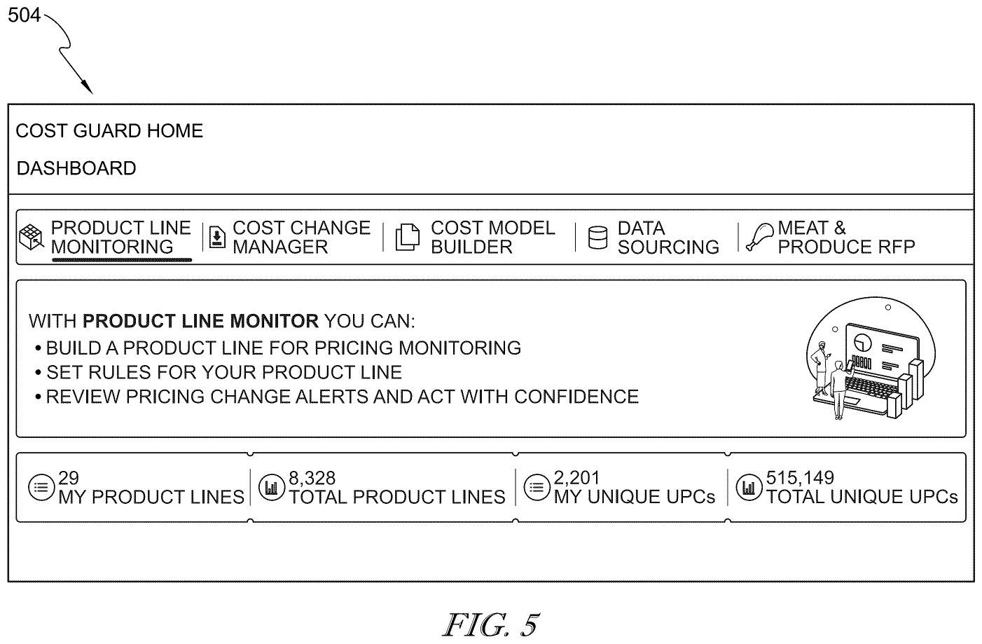

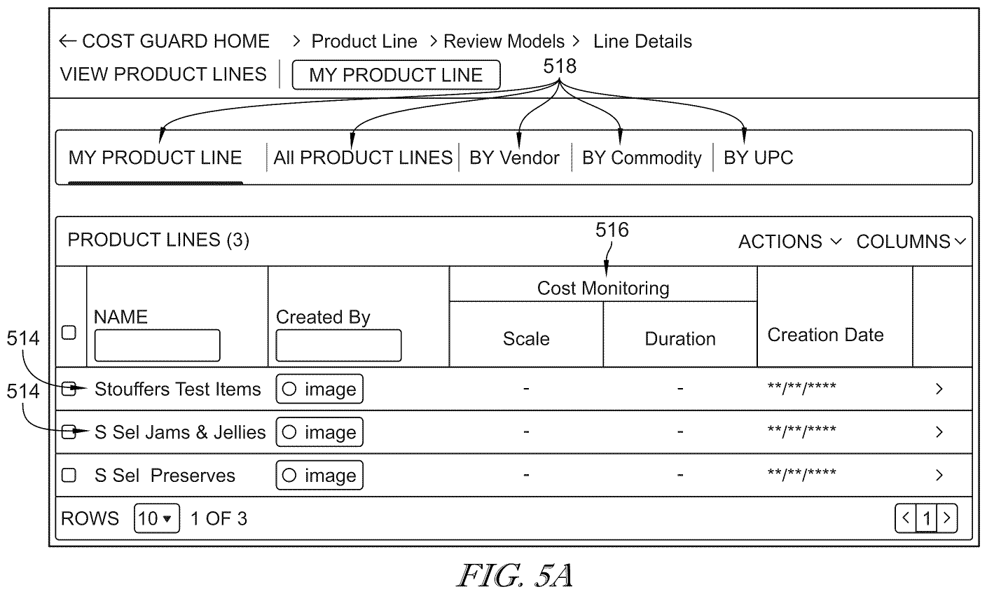

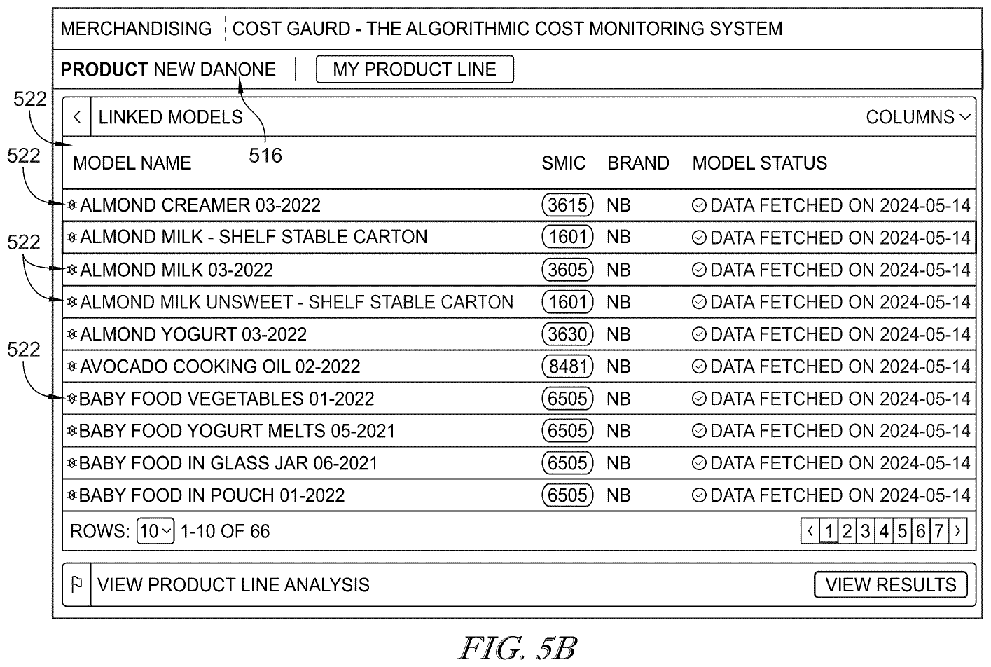

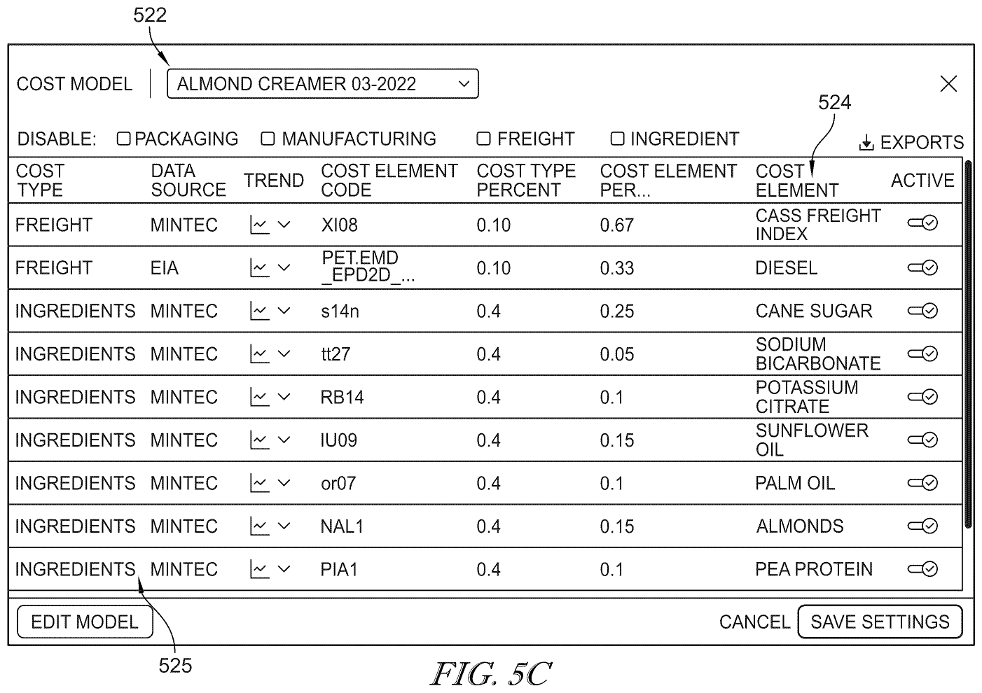

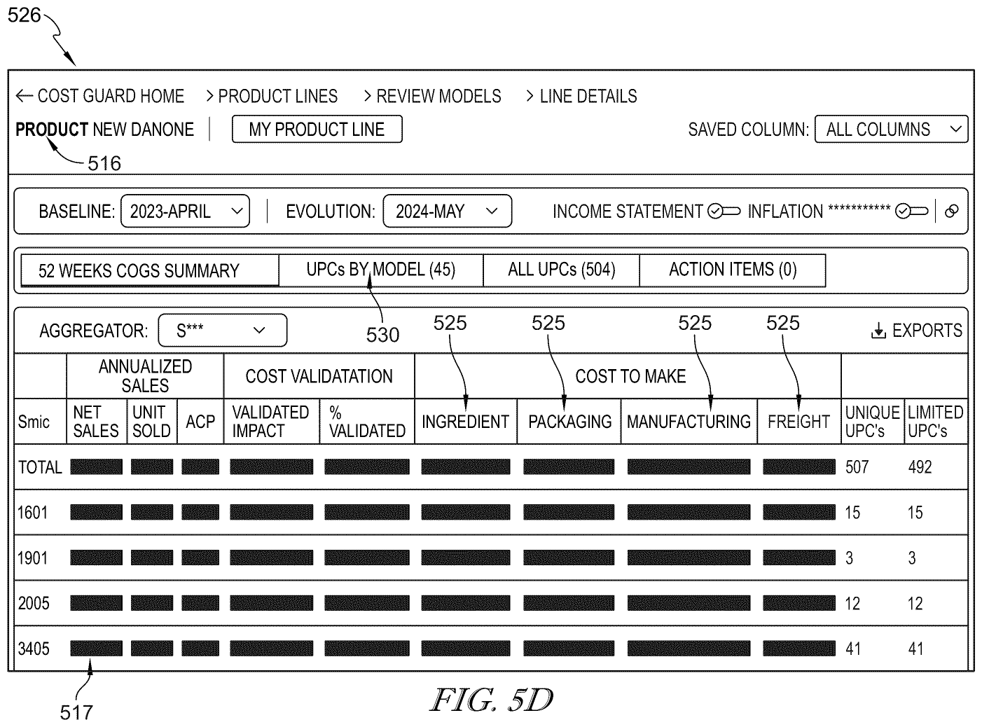

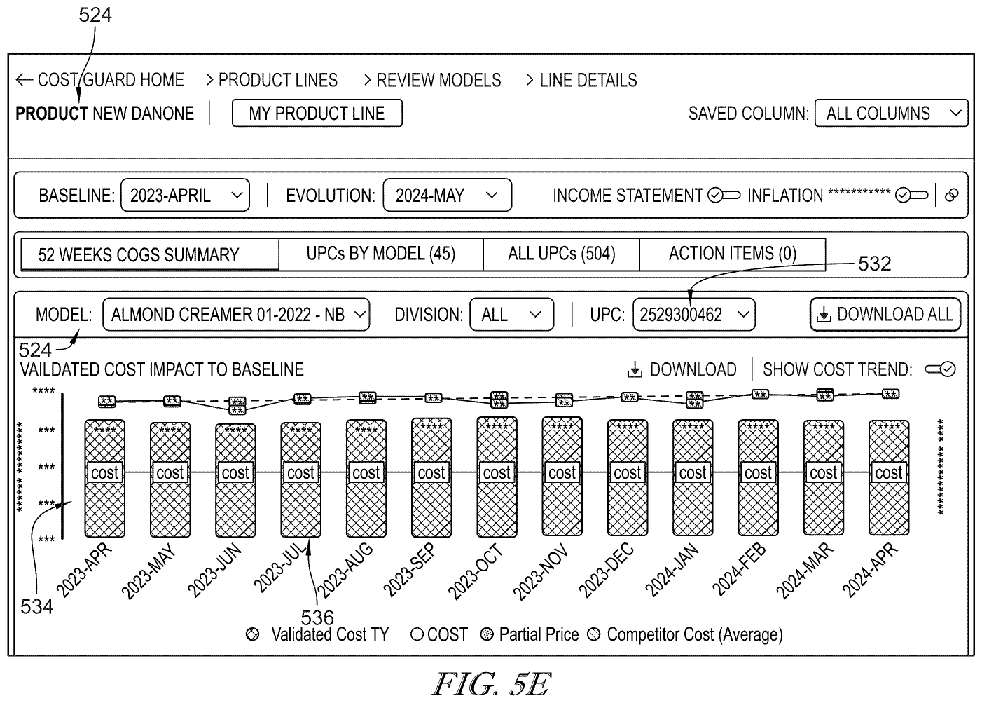

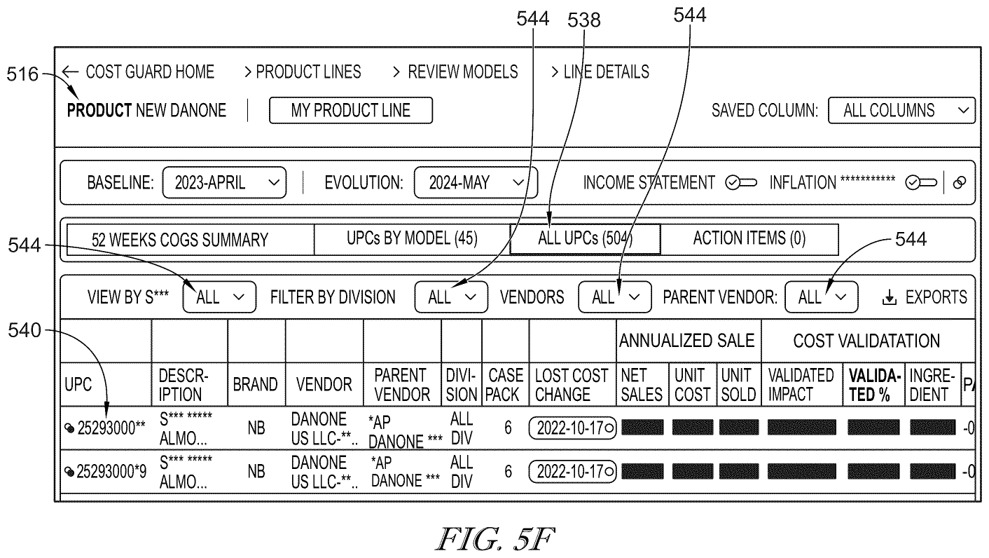

The product line module 504 interface in FIG. 5 allows modeled products to be grouped for individual and product line group cost analysis in the create produce line interface. Product line monitoring module 504 may build one or more product lines, set alerts based rules for product lines, and review alerts. Product line module 504 allows for monitoring of costs and cost trends over time using historical data from data sourcing module as well as predictive algorithms that incorporate key components of historical data trends, seasonality, current micro and macroeconomic data, commodity-related security trading prices to generate predictive costs to be incorporated into the cost model to generate overall product cost predictions.

An example of a structured, 3-phase approach to generating predictive cost components to be entered into a cost model is as follows
###1. **Data Collection and Preprocessing**
####**Historical Data**
   Collect historical price data for the commodity of interest. This data should span multiple years to capture long-term trends and seasonality patterns.
   Gather historical economic indicators (e.g., GDP growth rates, inflation rates, interest rates) that may affect commodity prices.
   Compile historical trading data for commodity-related securities, such as futures prices, options prices, and trading volumes.
####**Current Data**
   Obtain current economic indicators (e.g., GDP forecasts, inflation expectations, interest rates).
   Retrieve current trading prices and volumes for commodity-related securities.
   Collect current market sentiment data, such as news articles, social media trends, and expert opinions.
###2. **Feature Engineering**
####**Trend and Seasonality**
   Decompose the historical price data into trend, seasonality, and residual components using techniques such as Seasonal-Trend decomposition using LOESS (STL) or Holt-Winters exponential smoothing.
   Identify and quantify seasonal patterns, e.g., monthly, quarterly, or yearly cycles.
####**Macroeconomic Indicators**
   Create features representing key economic indicators (both historical and current) that are likely to impact commodity prices.
   Consider lagged versions of these indicators to account for delayed effects.
####**Market Sentiment**
   Use natural language processing (NLP) techniques to quantify market sentiment from textual data sources.
   Generate sentiment scores and include them as features in the model.
###3. **Model Selection and Training**
####**Time Series Models**
   **ARIMA/SARIMA**: For capturing linear relationships in time series data, including autoregressive and moving average components.
   **Exponential Smoothing (ETS)**: For modeling trends and seasonality explicitly.
   **State Space Models**: For more complex time series structures.
####**Machine Learning Models**
   **Gradient Boosting Machines (GBM)**: For capturing non-linear relationships and interactions between features.
   **Random Forests**: For robust modeling with feature importance insights.
   **Neural Networks (e.g., LSTM, RNN)**: For capturing complex temporal dependencies and patterns in the data.
####**Hybrid Models**
   Combine time series models with machine learning models to leverage the strengths of both approaches.
###4. **Model Evaluation and Validation**
   Split the data into training and test sets, ensuring that the test set represents the most recent data.
   Use cross-validation techniques to evaluate model performance on the training data.
   Assess model accuracy using metrics such as Mean Absolute Error (MAE), Mean Squared Error (MSE), and Root Mean Squared Error (RMSE).
###5. **Model Deployment and Monitoring**
   Implement the model in a production environment using a scalable infrastructure.
   Continuously monitor model performance and recalibrate the model periodically using new data to ensure accuracy and relevance.
###6. **Incorporate Into Cost Calculation*
   Predicted values of future commodity cost from the hybrid models may be manually uploaded or otherwise pulled at a cadence from a feeder system collecting the model data into data sourcing module to be incorporated into cost models to determine what future costs of products should be.

Groups of products may be identified and linked by UPC by selecting UPCs in a searchable interface in the product line module or by batch uploading a list of UPCs in the interface. Examples of product lines may be a group of UPCs of a product category or type, or a group of UPCs provided by a particular vendor. As illustrated, all defined product lines 514 may be viewed according to the categories 518 including user's product lines, all product lines, by vendor, by commodity, or by UPC. Each product line may further be configured with its own cost monitoring 516 predefined rules and alerts. For example, a notification can be set for the product line module to monitor a defined increase or decrease percentage in costs for all products in the product line within a defined time period. The alert may be an automatically generated email, a visual notification one the dashboard, or other visual notifications within the system. All product lines are saved and displayed along with cost monitoring 516 rules such as scale and duration. Scale is the percentage increase or decrease in costs set to be monitored over a particular duration, or period of time. For example, the product line can be set to monitor for a 3% increase or decrease in costs over a 1-month period for all products in the product line.

By selecting one or more product lines 514, product line details such as the cost models 522 which the associated products in the product line 514 fall under may be displayed along with the corresponding retailer sales material identification code SMIC, brand, and last date the model was refreshed as seen in FIG. 5B.

Further selection of a cost model 522 may display a view of all of the cost elements 524 that make up the cost model in the product line in FIG. 5C. The cost elements may be displayed in rows so that each row may be deselected or toggled on/off to activate or deactivate that cost element in the model. The cost element type, data source for each cost element, a selectable trend graph display for the cost element over time, cost element code, cost type percent, and cost element percent, for the cost model 522 may be displayed. Cost elements 524 may further be disabled by selecting an overall cost element type 525 such as packaging, manufacturing, freight, or ingredient, to exclude the cost element from the overall cost calculations for the model. By disabling cost elements, cost analysis and calculations of overall cost and cost changes for the module will specifically focus on a subset of the cost elements. For example, in FIG. 5C the user could disable cost element type 525 ingredients to preclude all rows with cost type ingredients from the modeling, costs, and alerts. Alternatively, the user could toggle off the active button to disable only specific cost elements within the ingredient cost type or across multiple cost types.

Additionally, a selection of “view product line analysis” in FIG. 5B provides a summary interface 526 of costs for the product line 516 in FIG. 5D. A 52 week cost of goods (COGs) summary may provide information, indicated by the black bar fields 517, including a total user or retailer sales information for the product line, cost validation, overall cost fluctuations for cost element types 525 and total unique UPCs for the selected product line 516. In the “Total” row, each of the business retailer's material item code SMIC cost models 524 may be broken out and displayed separately to display the retailer or sales information for the SMIC model, cost fluctuations for cost element types 525 for the SMIC model, and unique UPCs for the model. Cost validation may include the validated impact and the validation percent. Validated impact includes the predicted cost changes based on the modeled data and total cost of goods sold. Income statement toggle may be activated or deactivated to incorporate additional costs such as manufacturing or R&D costs information from publically traded company data sources. Inflation disparity toggle may be activated or deactivated to adjust costs based on an inflation percentage. Because inflation impacts different sectors or component types differently at different times, the inflation disparity is automatically calculated for different impact levels across the component types in the model based on inflation data ingested at the data sourcing module.

The system may compare cost element types to the previous year to display the differences between last year and the current year. If the display shows overall costs are down by X %, each column cost element type may be selected and further drilled down to determine which particular cost elements have decrease that are affecting the overall cost and cost change of the product.

Cost element types may be compared to the previous year so that users may view the differences between the current and previous years at a high level and then may select any of a number of columns including brand, description vendor, sales division or cost element information for a more detailed view of what types of costs are impacting overall cost.

By selecting the UPCs by model view button 530, a breakdown the validated monthly costs are graphically represented for the selected time period for a selected SMIC model 524 and UPC 532 from respective dropdown menus for the product line 516 as show in FIG. 5E.

A sales division is further filterable, but is illustrated to include “All”. The graph interface 534 quickly shows overall cost trends to a user and permits for easily selecting and changing the baseline for cost evaluation. For example, simply selecting or clicking on a bar in the bar graph 536 representative of cost values for a month, that month becomes the baseline cost for comparison in the summary of the cost information and values in those cost information fields update in real time base on the baseline selection. Alternatively, baseline and evaluation months may be selected based on dropdown menus. Further hovering or otherwise selecting a bar or month in the graph 536 provides validated cost for the bar's year and month, the cost, retail price, and competitor price for that UPC 532. Additional dropdown menus allow filtering of the UPC graphical interface by vendor for detailed costs as described above but further broken down specifically for the UPC for a particular selected vendor. Similarly, selection of an all UPCs button 538 shows a breakdown of current cost information for each UPC associated with the product line 516.

As shown in FIG. 5F, an additional display is selectable by the all UPCs button 538 to show data for all UPCs in the product line 516. Each UPC in the UPC column 540 is linked and selectable to further display an image of the item, description, and ingredients associated with that UPC. This display may also show details for each UPC including item description, whether the brand is the users own brand or a national brand. The information for all UPCs in the product line in this interface is further filterable by the vendor of record for the item, parent vendor for the item division, and SMIC via filters 544. This interface further shows for each UPC the case pack, or number of items in a case, annualized sales information, cost validation information, cost to make information, and the model name for the item. As in previous described interface views, the cost to make information may show overall cost percentage fluctuations for cost element types 525 for the UPC.

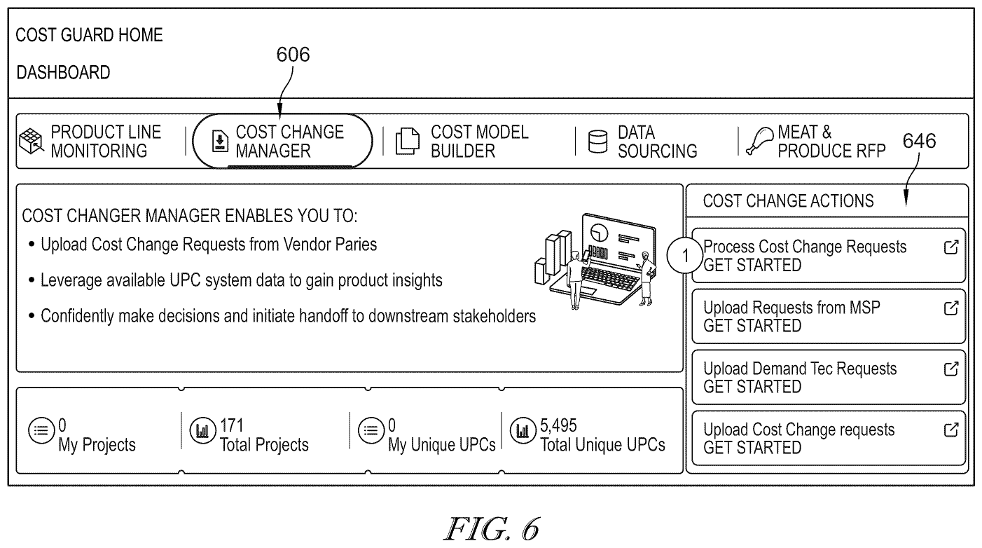

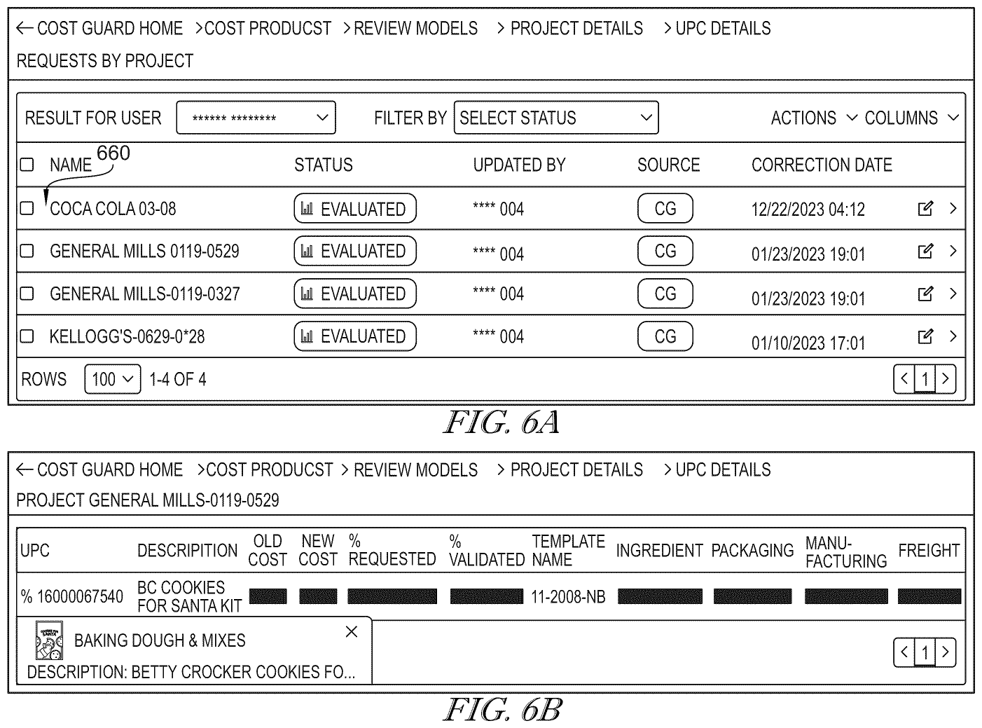

As illustrated in FIGS. 6, and 6A-6B, a cost change manager module 606 may further be provided to execute a plurality of cost change actions 646 including upload cost change requests from vendors, leverage available UPC data and visualization provided in the modules described in FIGS. 2-5 to compare cost trends to the requested changes, and provide handoffs for evaluation and/or approval among relevant stakeholders. For example, if a cost change request for a plurality of products is an increase and an associated product line with these products shows increases in costs for the corresponding products, the change can be approved. If the cost change request is an increase and the cost change trend is decreasing, then the change request can be rejected and renegotiated. A cost change request that is uploaded may be assigned a project name 660 and be listed in an evaluated section once the relevant cost models and a product line has been identified that correspond to the products in the change request in FIG. 6A and a product line established as described above with respect to FIG. 5. The baseline date may be, for example, the month of the last change request and the evaluation date may be the month of the change request. As illustrated in FIG. 6B, by clicking on the total line item, a further line breakdown of the cost changes is viewable including a picture of the saleable unit, the item description, and the item ingredients. Additionally, old cost, new cost, and cost element type changes are shown for all UPCs in the price change request project. Predicted costs as described above may also be modeled and generated in the cost change manager module. Evaluated cost change requests may also include approval or rejection information based on real time product line analysis cost information.

Although the invention has been explained in relation to various embodiments, it is to be understood that many other possible modifications and variations can be made without departing from the spirit and scope of the invention.

1) A system that determines cost of production for a plurality of products and maintains and updates the cost determinations comprising:
a plurality data sources comprising sources of items of information regarding costs for the plurality of products;
a cost model module having one or more cost models associated with each of the plurality products, the cost models incorporating data from the data sources into predefined cost element types to determine cost information for each of the plurality of products over time; and
a product line module configured to monitor cost changes over time for a product line formed of a predefined subset of the plurality of products, which displays and updates changes in cost information including cost element type costs, overall costs, and revenue for the products in the product line.

2) The system of claim 1, wherein the cost element types comprise one or more of commodity costs, labor costs, freight costs, or packaging costs.

3) The system of claim 2, wherein each of the cost element types comprise a plurality of individual cost elements, and each cost element type is further selectable to display a corresponding cost trend for each of the individual cost elements for one or more of the cost element types.

4) The system of claim 1, wherein the plurality of data sources comprise sources of items of information regarding commodity costs, labor costs, freight costs, and packaging costs.

5) The system of claim 1, further comprising a cost change manager module configured to receive change requests from vendor partners and compare the request with the trend of cost element types, overall costs, and revenue.

6) The system of claim 1, further comprising interactive elements displayed in a user interface configured for selection and deselection to update the displayed cost information over time based on the selection or deselection, or to filter to display a subset of the cost information.

7) The system of claim 6, wherein the interactive elements comprise toggles, buttons, hyperlinks, or other user-selectable features in a displayed area.

8) The system of claim 1, wherein the product line module further displays cost element type costs, overall costs, and revenue, for each UPC or cost model in the product line.

9) The system of claim 1, wherein the product line module comprises a plurality of product lines, wherein each of the plurality of product lines includes a predefined cost alert threshold that generates a notification when a change in the cost information exceeds a predefined threshold.

10) The system of claim 1, wherein the cost model module is configured to receive information about a new product and automatically associate the new product with an existing cost model based on attributes of the new product.

11) A user interface for a system that determines costs of production of a plurality of products comprising:
a dashboard displaying:
a cost model module to associate each of the plurality of products with one or more cost models, the cost models incorporating data from a plurality data sources into predefined cost element types to provide cost information for each of the plurality of products over time; and
a product line module configured to monitor cost changes over time for a product line formed of a predefined subset of the plurality of products, and display and update changes in cost information including cost element type costs, overall costs, and revenue for the products in the product line.

12) The user interface of claim 11, wherein the cost element types comprise one or more of commodity costs, labor costs, freight costs, or packaging costs.

13) The user interface of claim 12, wherein each of the cost element types comprise a plurality of individual cost elements, and each cost element type is further selectable to display a corresponding cost trend for each of the individual cost elements for one or more of the cost element types.

14) The user interface of claim 11, wherein the plurality of data sources comprise sources of items of information regarding commodity costs, labor costs, freight costs, and packaging costs that automatically feed into the one or more cost models on a pre-defined or real-time basis.

15) The user interface of claim 11, wherein the dashboard further comprises a cost change manager module configured to receive change requests from vendor partners and compare the request with the trend of cost element types, overall costs, and revenue of a product or product line.

16) The user interface of claim 11, further comprising interactive elements configured for selection and deselection to update the displayed cost information over time based on the selection or deselection, or to filter to display a subset of the cost information.

17) The user interface of claim 16, wherein the interactive elements comprise toggles, buttons, hyperlinks, or other user-selectable features in a displayed area.

18) The user interface of claim 11, wherein the product line module further displays cost element type costs, overall costs, and revenue, for each UPC or cost model in the product line.

19) The user interface of claim 11, wherein the product line module comprises a plurality of product lines, wherein each of the plurality of product lines includes a predefined cost alert threshold that generates a notification when a change in the cost information exceeds a predefined threshold.

20) The user interface of claim 11, wherein the cost model module is configured to receive information about a new product and automatically associate the new product with an existing cost model based on attributes of the new product.
